(19) United States
(12) Patent Application Publication
(10) Pub. No.: US 2026/0212667 A1
(43) Pub. Date: Jul. 23, 2026

(54) Vision Based System to Generate and Display Weed Data for Geo-Referenced Locations in an Agricultural Field

(71) Applicant: Precision Planting LLC, Tremont, IL (US)

(72) Inventors: Michael Strnad, Delavan, IL (US); Jason J. Stoller, Eureka, IL (US)

(21) Appl. No.: 19/136,527

(22) PCT Filed: Nov. 27, 2023
(86) PCT No.: PCT/IB2023/061917

§ 371 Date: Jun. 6, 2025

Related U.S. Application Data
(60) Provisional application No. 63/386,199, filed on Dec. 6, 2022.
(60) Provisional application No. 63/386,197, filed on Dec. 6, 2022.

(51) Int. Cl. G06V 20/10; G06V 10/56

(52) U.S. Cl. CPC G06V 20/188; G06V 10/56

(57) ABSTRACT

A system comprising an implement, a plurality of cameras disposed along a field operation width of the implement to capture images of target regions of an agricultural field as the implement travels through the agricultural field, and a processor communicatively coupled to the plurality of cameras. The processor is configured to determine weed type for different species of weeds based on the captured images and to determine color data with a different color for each species of weeds.

### CROSS REFERENCE TO RELATED APPLICATIONS

This application claims priority to U.S. Application Nos. 63/386197, filed 6 Dec. 2022, and 63/386199, filed 6 Dec. 2022, all of which are incorporated herein by reference in their entireties.

### TECHNICAL FIELD

Embodiments of the present disclosure relate to systems and methods for generating and displaying different weed data for geo-referenced locations in an agricultural field.

### BACKGROUND

Sprayers and other fluid application systems are used to apply fluids (such as fertilizer, herbicide, insecticide, and/or fungicide) to fields. Cameras located on the sprayers can capture images of the spray pattern, weeds, and plants growing in an agricultural field. Sprayers can apply too much fluid resulting in additional cost of fluid materials or not enough fluid resulting in weeds or diseases being able to continue spreading and reducing crop yield. The images contain a large amount of data that is difficult to analyze during an application pass.

### BRIEF DESCRIPTION OF THE DRAWINGS

FIG. 1 is an illustration of an agricultural crop sprayer.

FIG. 2 is a rear elevation view of a spray boom with cameras according to one embodiment.

FIG. 3 is a rear elevation view of a spray boom with cameras according to another embodiment.

FIG. 4 illustrates a flow diagram of one embodiment for a computer-implemented method of using images captured by a vision based system to generate and display weed data for target regions in geo-referenced locations in an agricultural field.

The user interface (UI) 500 of FIG. 5 displays different types of weeds with one color per weed species in accordance with one embodiment.

FIG. 6 illustrates a user interface 600 with a plurality of images in accordance with one embodiment.

FIG. 7 illustrates a user interface 700 to show a bar chart or histogram of different weed types in a field in accordance with one embodiment.

FIG. 8 illustrates an exemplary camera having multiple lenses in accordance with one embodiment.

FIG. 9 illustrates a camera having an image sensor for a first lens, an image sensor for second lens, and processing logic in accordance with one embodiment.

FIG. 10 illustrates a diagram of cameras and an arbiter that are disposed on an implement for a vision system 800 in accordance with one embodiment.

FIG. 11 illustrates a flow diagram of one embodiment for a computer-implemented method of processing data from images captured by multiple cameras of a vision based system.

FIG. 12A shows an example of a block diagram of a self-propelled implement 140 (e.g., sprayer, spreader, irrigation implement, etc.) in accordance with one embodiment.

FIG. 12B shows an example of a block diagram of a system 100 that includes a machine 102 (e.g., tractor, combine harvester, etc.) and an implement 1240 (e.g., planter, cultivator, plough, sprayer, spreader, irrigation implement, etc.) in accordance with one embodiment.

### BRIEF SUMMARY

In an aspect of the disclosure there is provided a system comprising an implement, a plurality of cameras disposed along a field operation width of the implement to capture images of target regions of an agricultural field as the implement travels through the agricultural field, and a processor communicatively coupled to the plurality of cameras. The processor is configured to determine weed type for different species of weeds based on the captured images and to determine color data with a different color for each species of weeds.

In one example of the system, further comprising a display device to display the weed type for different species of weeds with a different color being displayed for each species of weeds.

In one example of the system, wherein the processor is further configured to determine weed density.

In one example of the system, further comprising a display device to display a different color shading for different levels of weed density for each species of weeds.

In one example of the system, wherein the processor is further configured to determine weed present probability per geo-referenced location based on the captured images.

In one example of the system, wherein the processor is further configured to determine a crop identification per geo-referenced location based on the captured images.

In one example of the system, wherein the processor is further configured to determine a camera height from a camera to a ground level based on the captured images.

In one example of the system, wherein the processor is further configured to determine a crop stress indicator, a drought stress indicator, and insect indicator for different target regions based on captured images of the target regions.

In one example of the system, wherein the processor is further configured to generate a histogram for display for different types of weeds present at geo-referenced locations.

In one example of the system, wherein the histogram indicates a percentage of a first type of weed for a first size, a percentage of the first type of weed for a second size, and a percentage of the first type of weed for a third size.

In an aspect of the disclosure there is provided a vision system comprising a plurality of cameras disposed along a field operation width of an implement to capture images of target regions of an agricultural field as the implement travels through the agricultural field and a processor communicatively coupled to the plurality of cameras. The processor is configured to determine weed type for different species of weeds based on a computer vision analysis of the captured images and to determine color data with a different color for each species of weeds.

In one example of the vision system, further comprising a display device to display the weed type for different species of weeds with a different color being displayed for each species of weeds.

In one example of the vision system, wherein the processor is further configured to determine weed density.

In one example of the vision system, further comprising a display device to display a different color shading for different levels of weed density for each species of weeds.

In one example of the vision system, wherein the processor is further configured to determine weed present probability per geo-referenced location based on the captured images.

In one example of the vision system, wherein the processor is further configured to determine a camera height from a camera to a ground level based on the captured images.

In one example of the vision system, wherein the processor is further configured to determine a crop stress indicator, a drought stress indicator, and insect indicator for different target regions based on captured images of the target regions.

In an aspect of the disclosure there is provided a computer-implemented method, comprising receiving a sequence of images that are captured with one or more cameras disposed on an implement while the implement travels through an agricultural field, performing a computer vision analysis of the captured images to determine a weed type for different species of weeds in the agricultural field, and determining color data with a different color for each species of weeds.

In one example of the computer-implemented method, further comprising displaying, on a display device, the weed type for different species of weeds with a different color being displayed for each species of weeds.

In one example of the computer-implemented method, further comprising determining weed density and displaying, with a display device, a different color shading for different levels of weed density for each species of weeds.

In an aspect of the disclosure there is provided a system comprising an implement, a first camera and a second camera disposed along a field operation width of the implement to capture images of target regions of an agricultural field as the implement travels through the agricultural field, wherein each camera includes logic that is configured to process image data from the captured images and to generate processed data, and an arbiter communicatively coupled to the first and second cameras. The arbiter includes a processor that is configured to receive the processed data including a first weed present probability from the first camera for geo-referenced locations in the field, a second weed present probability from the second camera for geo-referenced locations in the field, and to generate a fused weed present probability for geo-referenced locations in the field based on the first weed present probability and the second weed present probability.

In one example of the system, wherein the fused weed present probability for geo-referenced locations in the field is based on averaging the first weed present probability and the second weed present probability.

In one example of the system, wherein the processor of the arbiter is further configured to receive the processed data including a first weed density from the first camera for geo-referenced locations in the field, a second weed density from the second camera for geo-referenced locations in the field, and to generate a fused weed density for geo-referenced locations in the field based on the first weed density and the second weed density.

In one example of the system, wherein the fused weed density for geo-referenced locations in the field is based on averaging the first weed density and the second weed density.

In one example of the system, wherein the processor of the arbiter is further configured to receive the processed data including a first camera height from the first camera for geo-referenced locations in the field, a second camera height from the second camera for geo-referenced locations in the field, and to generate a fused camera height for geo-referenced locations in the field based on the first camera height and the second camera height.

In one example of the system, wherein the processor of the arbiter is further configured to receive the processed data including a first crop detected matrix from the first camera for geo-referenced locations in the field, a second crop detected matrix from the second camera for geo-referenced locations in the field, and to generate a fused crop detected matrix for geo-referenced locations in the field based on the first crop detected matrix and the second crop detected matrix.

In one example of the system, wherein the fused crop detected matrix is based on applying a logical OR function to the first crop detected matrix and the second crop detected matrix.

In one example of the system, wherein a view of the first camera overlaps with a view of the second camera.

In one example of the system, further comprising a plurality of nozzles disposed along a field operation width of the implement to apply fluid to target regions of the agricultural field as the implement travels through the agricultural field.

In one example of the system, wherein the fused weed present probability for geo-referenced locations in the field is determined on per nozzle basis.

In one example of the system, wherein the system comprises a spray applicator system.

In an aspect of the disclosure there is provided a vision system comprising a first camera and a second camera disposed along a field operation width of an implement to capture images of target regions of an agricultural field as the implement travels through the agricultural field. Each camera includes logic that is configured to process image data from the captured images and to generate processed data and an arbiter communicatively coupled to the plurality of cameras. The arbiter includes a processor that is configured to receive the processed data including a first weed present probability from the first camera for geo-referenced locations in the field, a second weed present probability from the second camera for geo-referenced locations in the field, and to generate a fused weed present probability for geo-referenced locations in the field based on the first weed present probability and the second weed present probability.

In one example of the vision system, further comprising a third camera disposed on the implement, wherein the third camera is configured to capture images, to process image data from the captured images and to generate processed data including a third weed present probability, a third weed density, and a third crop detected matrix for geo-referenced locations in the field.

In one example of the vision system, wherein the processor of the arbiter is further configured to receive the processed data including a first weed present probability from the first camera for geo-referenced locations in the field, a second weed present probability from the second camera for geo-referenced locations in the field, a third weed present probability from the third camera for geo-referenced locations in the field, and to generate a fused weed present probability for geo-referenced locations in the field based on the first weed present probability, the second weed present probability, and the third weed present probability.

In one example of the vision system, wherein the processor of the arbiter is further configured to receive the processed data including a first weed density from the first camera for geo-referenced locations in the field, a second weed density from the second camera for geo-referenced locations in the field, a third weed density from the second camera for geo-referenced locations in the field, and to generate a fused weed density for geo-referenced locations in the field based on the first weed density, the second weed density, and the third weed density.

In one example of the vision system, wherein the fused weed density for geo-referenced locations in the field is based on averaging the first weed density, the second weed density, and the third weed density.

In one example of the vision system, wherein the processor of the arbiter is further configured to receive the processed data including a first camera height from the first camera for geo-referenced locations in the field, a second camera height from the second camera for geo-referenced locations in the field, and to generate a fused camera height for geo-referenced locations in the field based on the first camera height and the second camera height.

In one example of the vision system, wherein the processor of the arbiter is further configured to receive the processed data including a first crop detected matrix from the first camera for geo-referenced locations in the field, a second crop detected matrix from the second camera for geo-referenced locations in the field, and to generate a fused crop detected matrix for geo-referenced locations in the field based on the first crop detected matrix and the second crop detected matrix.

In one example of the vision system, wherein the fused crop detected matrix is based on applying a logical OR function to the first crop detected matrix and the second crop detected matrix.

In one example of the vision system, wherein a view of the first camera overlaps with a view of the second camera.

In one example of the vision system, wherein a view of the second camera overlaps with a view of the third camera.

### DETAILED DESCRIPTION

All references cited herein are incorporated herein in their entireties. If there is a conflict between a definition herein and in an incorporated reference, the definition herein shall control.

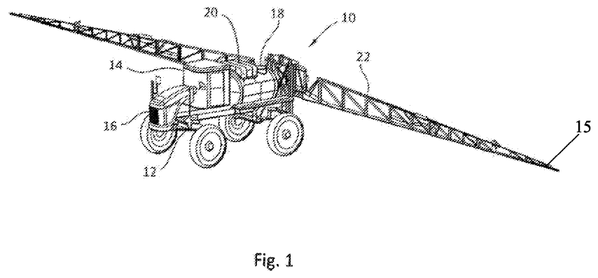

Referring to the drawings, wherein like reference numerals designate identical or corresponding parts throughout the several views, FIG. 1 illustrates an agricultural implement, such as a sprayer 10. While the system 15 can be used on a sprayer, the system can be used on any agricultural implement that is used to apply fluid to soil, such as a side-dress bar, a planter, a seeder, an irrigator, a center pivot irrigator, a tillage implement, a tractor, a cart, or a robot. A reference to boom or boom arm herein includes corresponding structures, such as a toolbar, in other agricultural implements.

FIG. 1 shows an agricultural crop sprayer 10 used to deliver chemicals to agricultural crops in a field. Agricultural sprayer 10 comprises a chassis 12 and a cab 14 mounted on the chassis 12. Cab 14 may house an operator and a number of controls for the agricultural sprayer 10. An engine 16 may be mounted on a forward portion of chassis 12 in front of cab 14 or may be mounted on a rearward portion of the chassis 12 behind the cab 14. The engine 16 may comprise, for example, a diesel engine or a gasoline powered internal combustion engine. The engine 16 provides energy to propel the agricultural sprayer 10 and also can be used to provide energy used to spray fluids from the sprayer 10.

Although a self-propelled application machine is shown and described hereinafter, it should be understood that the embodied invention is applicable to other agricultural sprayers including pull-type or towed sprayers and mounted sprayers, e.g. mounted on a 3-point linkage of an agricultural tractor.

The sprayer 10 further comprises a liquid storage tank 18 used to store a spray liquid to be sprayed on the field. The spray liquid can include chemicals, such as but not limited to, herbicides, pesticides, and/or fertilizers. Liquid storage tank 18 is to be mounted on chassis 12, either in front of or behind cab 14. The crop sprayer 10 can include more than one storage tank 18 to store different chemicals to be sprayed on the field. The stored chemicals may be dispersed by the sprayer 10 one at a time or different chemicals may be mixed and dispersed together in a variety of mixtures. The sprayer 10 further comprises a rinse water tank 20 used to store clean water, which can be used for storing a volume of clean water for use to rinse the plumbing and main tank 18 after a spraying operation.

At least one boom arm 22 on the sprayer 10 is used to distribute the fluid from the liquid tank 18 over a wide swath as the sprayer 10 is driven through the field. The boom arm 22 is provided as part of a spray applicator system 15 as illustrated in FIGS. 1-3, which further comprises an array of spray nozzles (in addition to cameras, and processors described later) arranged along the length of the boom arm 22 and suitable sprayer plumbing used to connect the liquid storage tank 18 with the spray nozzles. The sprayer plumbing will be understood to comprise any suitable tubing or piping arranged for fluid communication on the sprayer 10. Boom arm 22 can be in sections to permit folding of the boom arm for transport.

Additional components that can be included, such as control modules or lights, are disclosed in PCT Publication No. WO2020/178663 and U.S. Application No. 63/050,314, filed 10 Jul. 2020, respectively.

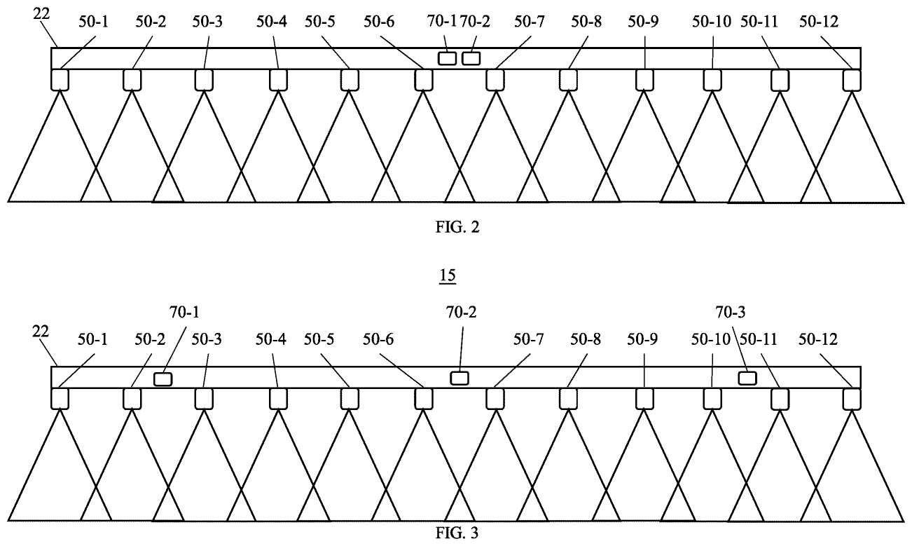

Illustrated in FIGS. 2 and 3, there are a plurality of nozzles 50 (50-1 to 50-12) disposed on boom arm 22. While illustrated with 12 nozzles 50, there can be any number of nozzles 50 disposed on boom arm 22. Nozzles 50 dispense material (such as fertilizer, herbicide, or pesticide) in a spray. In any of the embodiments, nozzles 50 can be actuated with a pulse width modulation (PWM) actuator to turn the nozzles 50 on and off. In one example, the PWM actuator drives to a specified position (e.g., full open position, full closed position) according to a pulse duration, which is a length of the signal.

Illustrated in FIG. 2, there are two cameras 70 (70-1 and 70-2) disposed on the boom arm 22 with each camera 70-1 and 70-2 disposed to view half of the boom arm 22. Illustrated in FIG. 3, there are a plurality of cameras 70 (70-1, 70-2, 70-3) each disposed on the boom arm 22 with each viewing a subsection of boom arm 22. While illustrated with three cameras 70, there can be additional cameras 70. In the plurality of camera 70 embodiments, the cameras 70 can each be disposed to view an equal number of nozzles 50 or any number of nozzles 50.

A combined camera 70 includes a light unit. A reference to camera 70 is to either a camera or camera/light unit unless otherwise specifically stated.

Camera 70 can be any type of camera. Examples of cameras include, but are not limited to, digital camera, line scan camera, monochrome, RGB (red, green blue), NIR (near infrared), SWIR (short wave infrared), MWIR (medium wave infrared), LWIR (long wave infrared), optical sensor (including receiver or transmitter/receiver), reflectance sensor, laser.

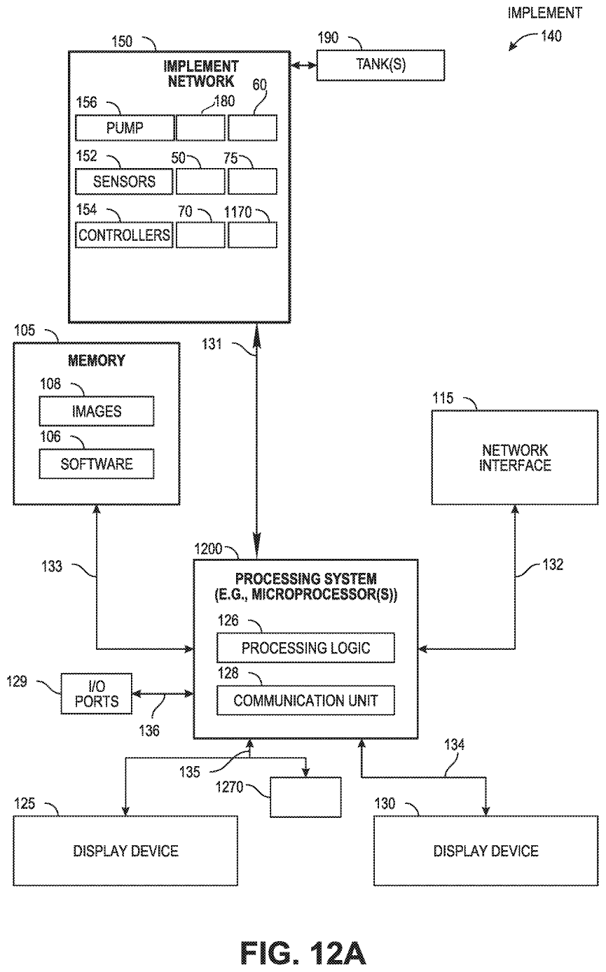

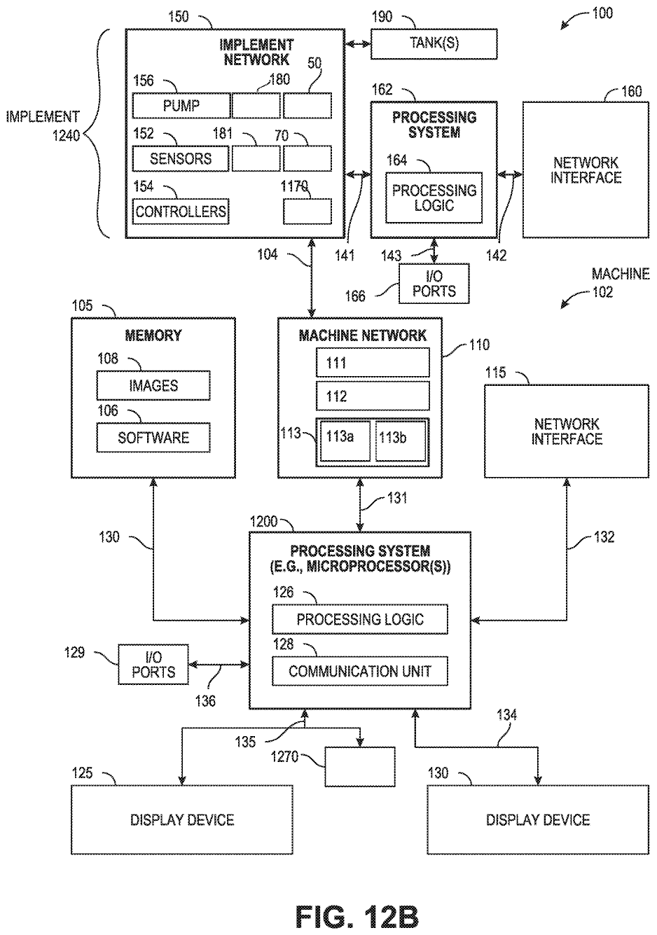

In one embodiment, nozzles 50 and cameras 70 are connected to a network. An example of a network is described in PCT Publication No. WO2020/039295A1 and is illustrated as implement network 150 in FIG. 12A and FIG. 12B.

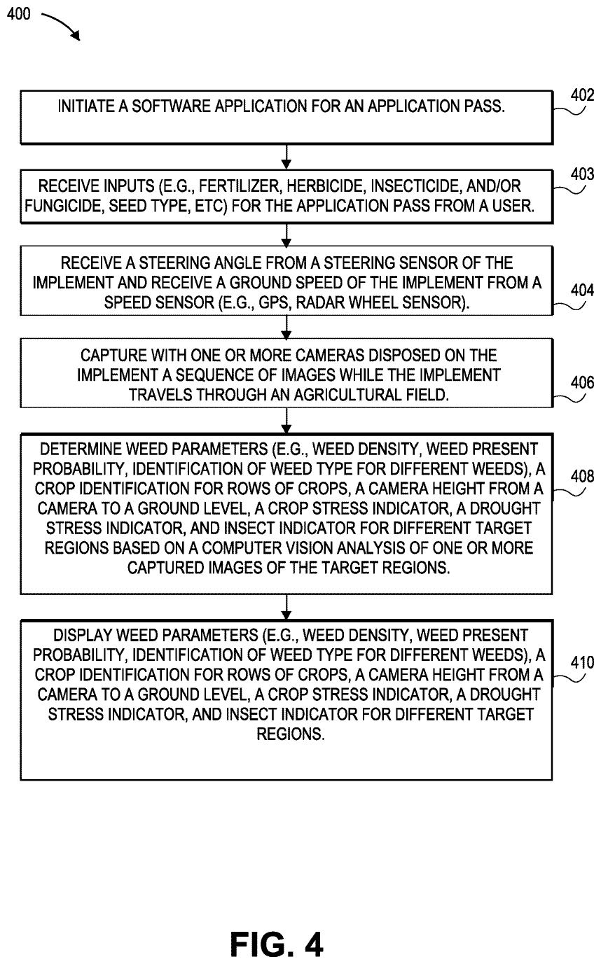

FIG. 4 illustrates a flow diagram of one embodiment for a computer-implemented method of using images captured by a vision based system to generate and display weed data for target regions in geo-referenced locations in an agricultural field. The vision based system (e.g., vision system 75, vision system 1170) includes one or more cameras that are disposed across a field operation width of an agricultural implement (or disposed along a length of a boom arm of an agricultural implement) that is traveling through a field for an application pass. The agricultural implement can be moving through the field in parallel with rows of plants. The method 400 is performed by processing logic that may comprise hardware (circuitry, dedicated logic, a processor, a graphics processor, a GPU, etc.), software (such as is run on a general purpose computer system or a dedicated machine or a device), or a combination of both. In one embodiment, the method 400 is performed by processing logic (e.g., processing logic 126) of a processing system or of a monitor (e.g., monitor 1000), or a processor of a vision system. The cameras can be attached to a boom or any implement as described herein.

At operation 402, the computer-implemented method initiates a software application for an application pass (e.g., fluid application, seed planting, scouting, etc.). At operation 403, the software application receives inputs (e.g., fertilizer, herbicide, insecticide, and/or fungicide, seed type, etc.) for the application pass from a user (e.g., grower, farmer). At operation 404, the software application receives a steering angle from a steering sensor of the implement and receives a ground speed of the implement from a speed sensor (e.g., GPS, RADAR wheel sensor). At operation 406, one or more cameras disposed along a field operation width of the implement capture a sequence of images while the implement travels through an agricultural field. In one example, the agricultural implement can be moving through the field in parallel with rows of plants and have numerous spray nozzles for a fluid application. The steering angle will indicate whether the implement is traveling in a straight line or with curvature.

At operation 408, the computer-implemented method determines different parameters including two or more of weed parameters (e.g., weed density, weed present probability, identification of weed type for different weeds), a crop identification for rows of crops, a camera height from a camera to a ground level, a crop stress indicator, a drought stress indicator, and insect indicator for different target regions (e.g., 80″ by 80″, 100″ by 100″, 40″ by 40″, any unit area, per acre) based on a computer vision analysis of one or more captured images of the target regions. A neural network can be used to derive meaningful information from the images for the analysis and detection of weeds, crops, disease, or insects in the field. One or more parameters can be determined in real time as the implement travels through a field. A plurality of nozzles (e.g., 4 to 20 nozzles) can be located on the implement in close proximity to each target region. Cameras capture the one or more images of each target region when the target region is slightly in front (e.g., 5 to 20 ft) of the cameras as the implement passes through the field.

At operation 410, the computer-implemented method displays different parameters including one or more of weed parameters (e.g., weed density, weed present probability, identification of weed type for different weeds), a crop identification, a camera height from a camera to a ground level, a crop stress indicator, a drought stress indicator, and insect indicator for different target regions (e.g., 80″ by 80″, 100″ by 100″, 40″ by 40″, any unit area, per acre) based on one or more images of the target regions on a display device or on a monitor in real time as the implement travels through a field or post process analysis may occur after the implement drives past target regions. The display device or monitor can be located in a cab of a tractor that is towing the implement, integrated with a self-propelled implement, or the display device can be part of a user's electronic device.

The weed types can be displayed with a different color for each weed species (e.g., annual grasses, broadleaf, foxtail, waterhemp, velvetleaf, horseweed (marestail), giant ragweed, lambsquarters, kochia, morning glory, hawkweed, deer tongue, bull thistle, cocklebur, etc.). A weed density can be displayed as a different level of shading for different density levels. A histogram can be displayed for different weeds present at geo-referenced locations.

In other embodiments, different levels of crop stress, drought stress, or insect eating indicators can be displayed in different colors or different shading on a display device for different regions of the field.

FIGS. 5-7 show illustrations for displaying different parameters including weed metrics in accordance with one embodiment. Cameras spaced across a width of an implement capture images that are analyzed to generate metrics and mapping of the metrics with geo-referenced locations in an agricultural field. The cameras are disposed on an implement that is traveling at a known speed through rows of plants in an agricultural field.

The user interface (UI) 500 displays different types of weeds with one color per weed species. The UI 500 shows grasses 510, 511 in a color (e.g., yellow) with a heavier color shading for higher density grass 510 and a lighter color shading for lower density grass 511. The broadleaf weeds 520, 521 are shown in a color (e.g., red) with a heavier color shading for higher density broadleaf weed 520 and a lighter color shading for lower density broadleaf weed 521. Mixed weeds 530 represents a region with a combination of weeds such as grasses and broadleaf weeds. The no weed 540 regions can have a different color (e.g., green) than other regions having weeds.

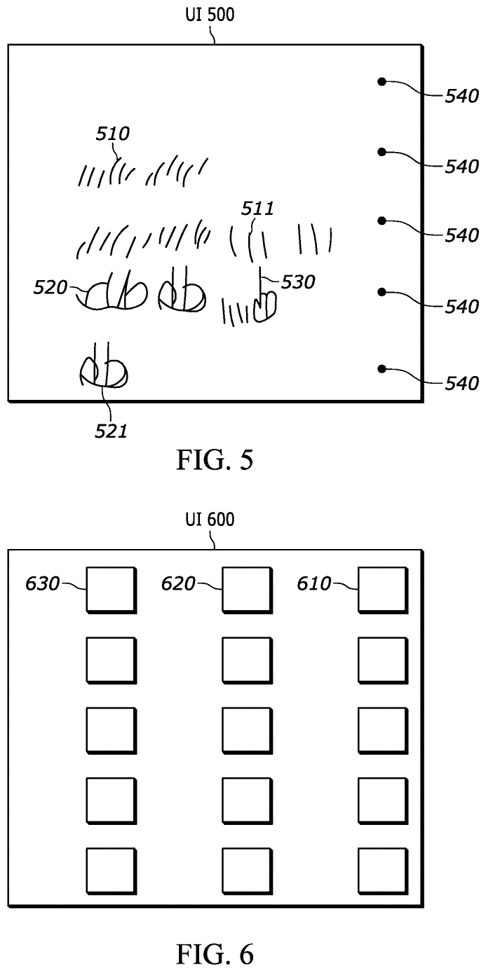

FIG. 6 illustrates a user interface 600 with a plurality of saved images in accordance with one embodiment. Each image (e.g., 610, 620, 630) can be selected by a user and the image will then be displayed to show current weed and crop conditions in regions of the field. In one example, an image 630 corresponds to a region for grass 510. The user can view the image to determine the extent of grass 510 in this region or view other images to determine a weed density for a region. Images can be saved to display regions of the agricultural field having different weed density.

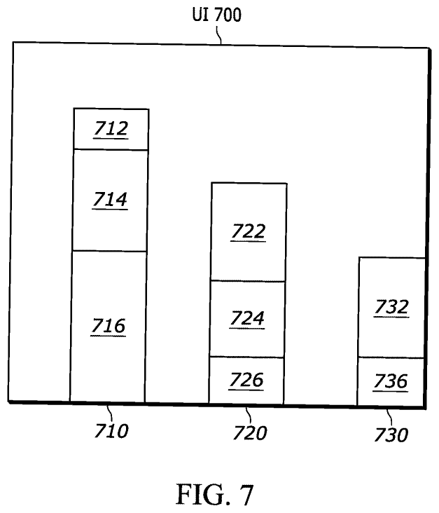

FIG. 7 illustrates a user interface 700 to show a bar chart or histogram of different weed types in a field in accordance with one embodiment. A vertical bar 710 has size components 712, 714, and 716 to represent a quantity of a first type of weed in regions of the field. In one example, a component 712 represents a quantity or percentage of the first type of weed having a small size, a component 714 represents a quantity or percentage of the first type of weed having a medium size, and a component 716 represents a quantity or percentage of the first type of weed having a large size.

In another example, a component 712 represents a quantity or percentage of the first type of weed having a small size in a first color with a first shading, a component 714 represents a quantity or percentage of the first type of weed having a medium size in the first color with a second shading, and a component 716 represents a quantity or percentage of the first type of weed having a large size in the first color with a third shading.

A vertical bar 720 has size components 722, 724, and 726 to represent a quantity of a second type of weed in regions of the field. In one example, a component 722 represents a quantity or percentage of the second type of weed having a small size in a second color with a first shading, a component 714 represents a quantity or percentage of the second type of weed having a medium size in the second color with a second shading, and a component 716 represents a quantity or percentage of the second type of weed having a large size in the second color with a third shading.

A vertical bar 730 has size components 732 and 736 to represent a quantity of a third type of weed in regions of the field. In one example, a component 732 represents a quantity or percentage of the third type of weed having a small size in a third color with a first shading, and a component 736 represents a quantity or percentage of the third type of weed having a large size in the third color with a second shading.

Alternatively, a histogram can show a percent for each weed species type within regions of the field.

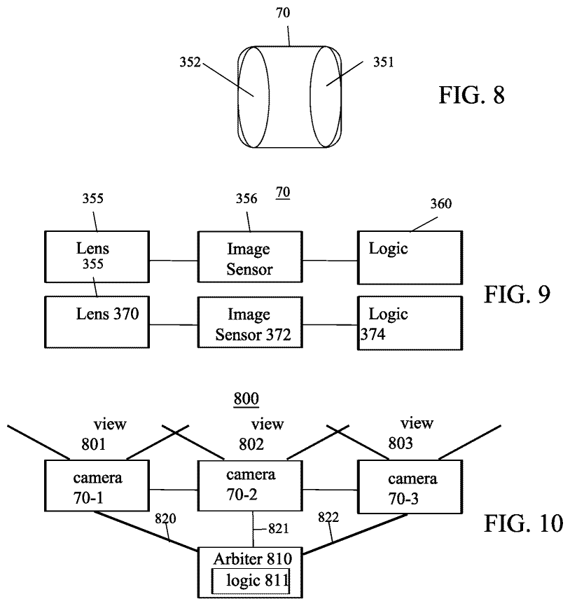

Cameras 70 can be installed at various locations across a field operation width of an agricultural implement (or disposed along a length of a boom arm of an agricultural implement). Cameras 70 can have a plurality of lenses. An exemplary camera 70 is illustrated in FIG. 8 with lenses 351 and 352. Each lens 351 and lens 352 can have a different field of view. The different fields of view can be obtained by different focal lengths of the lens. Cameras 70 can be positioned to view spray from nozzles 50 for flow, blockage, or drift, to view for guidance, for obstacle avoidance, to identify plants, to identify type of weeds, to identify insects, to identify diseases, or combinations thereof.

In a camera system, the image sensor receives incident light (photons) that is focused through a lens or other optics. Depending on whether the sensor is CCD or CMOS, the image sensor will transfer information to the next stage as either a voltage or a digital signal. CMOS sensors convert photons into electrons, then to a voltage, and then into a digital value using an on-chip Analog to Digital Converter (ADC).

In some embodiments, a camera 70 includes an image sensor 356 for lens 355 and an image sensor 372 for lens 370 of FIG. 9. In one example, the sensor 356 is a RGB image sensor with an IR blocking filter. The sensor 356 may have millions of photosites that each represent a pixel of a captured image. Photosites catches the light, but cannot distinguish between the different wavelengths—therefore cannot capture the color. To get a color image, a thin color filter array is placed over the photodiodes. This filter includes RGB blocks of which each is placed on top of the photodiode. Now, each of the RGB blocks can capture the intensity of the RGB. Processing logic (e.g., a processor, a graphics processor, a graphics processing unit (GPU)) of the logic 360 analyzes the color and intensity of each photosite and the processed data is temporarily buffered or stored in memory of the camera until being sent to an arbiter 810 of FIG. 10.

The image sensor 372 has a filter that allows IR light to pass to the image sensor 372. The first and second image sensors have a slight offset from each other. A processor of the logic 374 analyzes the intensity of each photosite and the processed data is temporarily buffered or stored in memory of the camera until being sent to an arbiter 810 of FIG. 10. In another embodiment, the image sensors 356 and 372 share the same digital logic.

FIG. 10 illustrates a diagram of cameras and an arbiter that are disposed on an implement for a vision system 800 in accordance with one embodiment. The vision system 800 includes at least two cameras and as illustrated includes cameras 70-1, 70-2, and 70-3 disposed along a field operation width of an implement (e.g., planter, harvester, etc.) or length of a boom arm of a sprayer to capture images of plants and weeds in the field as the implement travels through the field. Each camera includes a lens, an image sensor, and logic as described for FIG. 9. The cameras and an upstream arbiter are communicatively coupled to each other with wired or wireless links 820-822. The cameras may be communicatively coupled to each other with wired or wireless links.

Each camera 70-1, 70-2, and 70-3 has a view 801, 802, and 803, respectively to capture images of the field and processes image data with logic to generate processed data that is sent to the upstream arbiter 810 via links 820-822. The processed data can include different parameters including a weed present probability for geo-referenced locations in the field, a weed density for geo-referenced locations in the field, a camera height with respect to a ground level, and a crop detected matrix for geo-referenced locations. The processed data can be inference data provided as an input to the arbiter. A view 870-1 of camera 70-1 overlaps with a view 870-2 of camera 70-2. A view 870-3 of camera 70-3 overlaps with the view 870-2 of camera 70-2.

Processing logic 811 (e.g., a processor, a graphics processor, a graphics processing unit (GPU)) of the arbiter 810 performs processing operations. The arbiter 810 receives processed data from each camera 70-1, 70-2, and 70-3 and combines or fuses this data from different cameras to determine different parameters including a weed present probability for geo-referenced locations in the field, a weed density for geo-referenced locations in the field, a camera height with respect to a ground level, and a crop detected matrix for geo-referenced locations. For a fluid application, the different parameters are determined on a per nozzle basis.

In one example, the arbiter 810 applies a logical OR function to the processed data from different cameras. A crop detected matrix from different cameras can be used as input for a logical OR function. If a first camera detects corn and a second camera detects soybeans for the same geo-referenced location, then the arbiter 810 generates an output indicating corn and soybeans for the geo-referenced location. Weed present probability data from different cameras can be averaged to generate an averaged weed present probability for each geo-referenced location in the field. Weed density data from different cameras can be averaged to generate an averaged weed density data for each geo-referenced location in the field. For camera height, a linear interpolation can be performed on different camera heights received from the cameras.

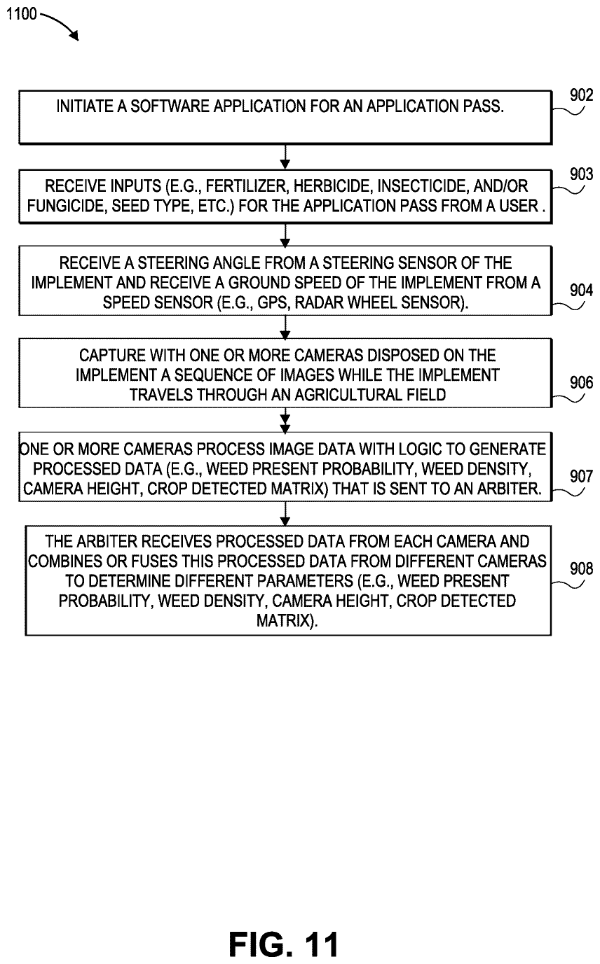

FIG. 11 illustrates a flow diagram of one embodiment for a computer-implemented method of processing data from images captured by multiple cameras of a vision based system. The vision based system (e.g., system 800, 1170) includes one or more cameras that are disposed along a field operation width of an agricultural implement that is traveling through a field for an application pass. The agricultural implement can be moving through the field in parallel with rows of plants and operate across numerous rows (e.g., 8 rows, 12 rows, etc.). The method 1100 is performed by processing logic that may comprise hardware (circuitry, dedicated logic, a processor, a graphics processor, a GPU, etc.), software (such as is run on a general purpose computer system or a dedicated machine or a device), or a combination of both. In one embodiment, the method 1100 is performed by processing logic (e.g., processing logic 126) of an implement or processing logic of a vision based system. The cameras can be attached to a boom or any implement as described herein.

At operation 902, the computer-implemented method initiates a software application for an application pass (e.g., fluid application, seed planting, scouting, etc.). At operation 903, the software application receives inputs (e.g., fertilizer, herbicide, insecticide, and/or fungicide, seed type, etc.) for the application pass from a user (e.g., grower, farmer). At operation 904, the software application receives a steering angle from a steering sensor of the implement and receives a ground speed of the implement from a speed sensor (e.g., GPS, RADAR wheel sensor). At operation 906, one or more cameras (e.g., cameras 70-1, 70-2, and 70-3) that are disposed along a field operation width of an implement capture images of the field. At operation 907, the one or more cameras process image data with logic to generate processed data that is sent to the arbiter 810 (e.g., sent via links 820-822). The processed data can include different parameters including a weed present probability for geo-referenced locations in the field, a weed density for geo-referenced locations in the field, a camera height with respect to a ground level, and a crop detected matrix for geo-referenced locations.

Processing logic (e.g., a processor, a graphics processor, a graphics processing unit (GPU)) of the arbiter 810 performs processing operations. At operation 908, the arbiter receives processed data from each camera (e.g., cameras 70-1, 70-2, and 70-3) and combines or fuses this data from different cameras to determine different parameters including a weed present probability for geo-referenced locations in the field, a weed density for geo-referenced locations in the field, a camera height with respect to a ground level, and a crop detected matrix for geo-referenced locations. The fused data can be determined at a granularity of per nozzle for a sprayer implement having nozzles disposed along a length of the spray boom.

Although the operations in the computer-implemented methods disclosed herein are shown in a particular order, the order of the actions can be modified. Thus, the illustrated embodiments can be performed in a different order, and some operations may be performed in parallel. Some of the operations listed in the methods disclosed herein are optional in accordance with certain embodiments. The numbering of the operations presented is for the sake of clarity and is not intended to prescribe an order of operations in which the various operations must occur. Additionally, operations from the various flows may be utilized in a variety of combinations.

Cameras 70 can be connected to a display device or a monitor 1000, such as the monitor disclosed in U.S. Pat. No. 8,078,367. Camera 70, display device, processing system, or monitor 1000 can each process the images captured by camera 70 or share the processing of the images. In one embodiment, the images captured by camera 70 can be processed in camera 70 and the processed images can be sent to monitor 1000. In another embodiment, the images can be sent to monitor 1000 for processing. Processed images can be used to identify flow, to identify blockage, to identify drift, to view for guidance, for obstacle avoidance, to identify plants, to identify weeds, to identify insects, to identify diseases, or combinations thereof. Once identified, monitor 1000 can alert an operator of the condition and/or send a signal to a device to address the identified condition, such as to a nozzle 50 to activate to apply herbicide to a weed.

FIG. 12A shows an example of a block diagram of a self-propelled implement 140 (e.g., sprayer, spreader, irrigation implement, etc.) in accordance with one embodiment. The implement 140 includes a processing system 1200, memory 105, and a network interface 115 for communicating with other systems or devices. The network interface 115 can include at least one of a GPS transceiver, a WLAN transceiver (e.g., WiFi), an infrared transceiver, a Bluetooth transceiver, Ethernet, or other interfaces from communications with other devices and systems. The network interface 115 may be integrated with the implement network 150 or separate from the implement network 150 as illustrated in FIG. 12A. The I/O ports 129 (e.g., diagnostic/on board diagnostic (OBD) port) enable communication with another data processing system or device (e.g., display devices, sensors, etc.).

In one example, the self-propelled implement 140 performs operations for fluid applications of a field. Data associated with the fluid applications can be displayed on at least one of the display devices 125 and 130.

The processing system 1200 may include one or more microprocessors, processors, a system on a chip (integrated circuit), or one or more microcontrollers. The processing system includes processing logic 126 for executing software instructions of one or more programs and a communication unit 128 (e.g., transmitter, transceiver) for transmitting and receiving communications from the network interface 115 or implement network 150. The communication unit 128 may be integrated with the processing system or separate from the processing system.

Processing logic 126 including one or more processors may process the communications received from the communication unit 128 including agricultural data (e.g., planting data, GPS data, fluid application data, flow rates, etc.). The system 1200 includes memory 105 for storing data and programs for execution (software 106) by the processing system. The memory 105 can store, for example, software components such as fluid application software for analysis of fluid applications for performing operations of the present disclosure, or any other software application or module, images (e.g., captured images of crops, images of a spray pattern for rows of crops, images for camera calibrations), alerts, maps, etc. The memory 105 can be any known form of a machine readable non-transitory storage medium, such as semiconductor memory (e.g., flash; SRAM; DRAM; etc.) or non-volatile memory, such as hard disks or solid-state drive. The system can also include an audio input/output subsystem (not shown) which may include a microphone and a speaker for, for example, receiving and sending voice commands or for user authentication or authorization (e.g., biometrics).

The processing system 1200 communicates bi-directionally with memory 105, implement network 150, network interface 115, display device 130, display device 125, and I/O ports 129 via communication links 131-136, respectively.

Display devices 125 and 130 can provide visual user interfaces for a user or operator. The display devices may include display controllers. In one embodiment, the display device 125 is a portable tablet device or computing device with a touchscreen that displays data (e.g., weed parameters (e.g., weed density, weed present probability, identification of weed type for different weeds), a crop identification, a camera height from a camera to a ground level, a crop stress indicator, a drought stress indicator, and insect indicator for different target regions, planting application data, liquid or fluid application data, captured images, localized view map layer, high definition field maps of as-applied liquid or fluid application data, as-planted or as-harvested data or other agricultural variables or parameters, yield maps, alerts, etc.) and data generated by an agricultural data analysis software application and receives input from the user or operator for an exploded view of a region of a field, monitoring and controlling field operations. The operations may include configuration of the machine or implement, reporting of data, control of the machine or implement including sensors and controllers, and storage of the data generated. The display device 1230 may be a display (e.g., display provided by an original equipment manufacturer (OEM)) that displays images and data for a localized view map layer, as-applied liquid or fluid application data, as-planted or as-harvested data, yield data, controlling an implement (e.g., planter, tractor, combine, sprayer, etc.), steering the implement, and monitoring the implement (e.g., planter, combine, sprayer, etc.). A cab control module 1270 may include an additional control module for enabling or disabling certain components or devices of the implement.

The implement 140 (e.g., planter, cultivator, plough, sprayer, spreader, irrigation, implement, etc.) includes an implement network 150 having multiple networks. The implement network 150 having multiple networks (e.g., Ethernet network, Power over Ethernet (POE) network, a controller area network (CAN) serial bus protocol network, an ISOBUS network, etc.) may include a pump 156 for pumping liquid or fluid from a storage tank(s) 190 to row units of the implement, communication module 180 for receiving communications from controllers and sensors and transmitting these communications. In one example, the implement network 150 includes nozzles 50 and vision system 75 having cameras and processors for various embodiments of this present disclosure.

Sensors 152 (e.g., speed sensors, seed sensors for detecting passage of seed, downforce sensors, actuator valves, OEM sensors, flow sensors, etc.), controllers 154 (e.g., drive system, GPS receiver), and the processing system 120 control and monitoring operations of the implement.

The OEM sensors may be moisture sensors or flow sensors, speed sensors for the implement, fluid application sensors for a sprayer, or vacuum, lift, lower sensors for an implement. For example, the controllers may include processors in communication with a plurality of sensors. The processors are configured to process data (e.g., fluid application data) and transmit processed data to the processing system 120. The controllers and sensors may be used for monitoring motors and drives on the implement.

FIG. 12B shows an example of a block diagram of a system 100 that includes a machine 102 (e.g., tractor, combine harvester, etc.) and an implement 1240 (e.g., planter, cultivator, plough, sprayer, spreader, irrigation implement, etc.) in accordance with one embodiment. The machine 102 includes a processing system 1200, memory 105, machine network 110 that includes multiple networks (e.g., an Ethernet network, a network with a switched power line coupled with a communications channel (e.g., Power over Ethernet (PoE) network), a controller area network (CAN) serial bus protocol network, an ISOBUS network, etc.), and a network interface 115 for communicating with other systems or devices including the implement 1240. The machine network 110 includes sensors 112 (e.g., speed sensors), controllers 111 (e.g., GPS receiver, radar unit) for controlling and monitoring operations of the machine or implement. The network interface 115 can include at least one of a GPS transceiver, a WLAN transceiver (e.g., WiFi), an infrared transceiver, a Bluetooth transceiver, Ethernet, or other interfaces from communications with other devices and systems including the implement 1240. The network interface 115 may be integrated with the machine network 110 or separate from the machine network 110 as illustrated in FIG. 12B. The I/O ports 129 (e.g., diagnostic/on board diagnostic (OBD) port) enable communication with another data processing system or device (e.g., display devices, sensors, etc.).

In one example, the machine is a self-propelled machine that performs operations of a tractor that is coupled to and tows an implement for planting or fluid applications of a field. Data associated with the planting or fluid applications can be displayed on at least one of the display devices 125 and 130.

The processing system 1200 may include one or more microprocessors, processors, a system on a chip (integrated circuit), or one or more microcontrollers. The processing system includes processing logic 126 for executing software instructions of one or more programs and a communication unit 128 (e.g., transmitter, transceiver) for transmitting and receiving communications from the machine via machine network 110 or network interface 115 or implement via implement network 150 or network interface 160. The communication unit 128 may be integrated with the processing system or separate from the processing system. In one embodiment, the communication unit 128 is in data communication with the machine network 110 and implement network 150 via a diagnostic/OBD port of the I/O ports 129 or via network devices 113a and 113b. A communication module 113 includes network devices 113a and 113b. The communication module 113 may be integrated with the communication unit 128 or a separate component.

Processing logic 126 including one or more processors may process the communications received from the communication unit 128 including agricultural data (e.g., planting data, GPS data, liquid application data, flow rates, weed parameters (e.g., weed density, weed present probability, identification of weed type for different weeds), a crop identification, a camera height from a camera to a ground level, a crop stress indicator, a drought stress indicator, and insect indicator for different target regions, etc.). The system 1200 includes memory 105 for storing data and programs for execution (software 106) by the processing system. The memory 105 can store, for example, software components such as planting application software for analysis of planting applications for performing operations of the present disclosure, or any other software application or module, images (e.g., images for camera calibrations, captured images of crops), alerts, maps, etc. The memory 105 can be any known form of a machine readable non-transitory storage medium, such as semiconductor memory (e.g., flash; SRAM; DRAM; etc.) or non-volatile memory, such as hard disks or solid-state drive. The system can also include an audio input/output subsystem (not shown) which may include a microphone and a speaker for, for example, receiving and sending voice commands or for user authentication or authorization (e.g., biometrics).

The processing system 120 communicates bi-directionally with memory 105, machine network 110, network interface 115, display device 130, display device 125, and I/O ports 129 via communication links 130-136, respectively.

Display devices 125 and 130 can provide visual user interfaces for a user or operator. The display devices may include display controllers. In one embodiment, the display device 125 is a portable tablet device or computing device with a touchscreen that displays data (e.g., weed parameters (e.g., weed density, weed present probability, identification of weed type for different weeds), a crop identification, a camera height from a camera to a ground level, a crop stress indicator, a drought stress indicator, and insect indicator for different target regions, planting application data, liquid or fluid application data, captured images, localized view map layer, high definition field maps of as-applied liquid or fluid application data, as-planted or as-harvested data or other agricultural variables or parameters, yield maps, alerts, etc.) and data generated by an agricultural data analysis software application and receives input from the user or operator for an exploded view of a region of a field, monitoring and controlling field operations. The operations may include configuration of the machine or implement, reporting of data, control of the machine or implement including sensors and controllers, and storage of the data generated. The display device 1230 may be a display (e.g., display provided by an original equipment manufacturer (OEM)) that displays images and data for a localized view map layer, as-applied liquid or fluid application data, as-planted or as-harvested data, yield data, weed parameters (e.g., weed density, weed present probability, identification of weed type for different weeds), a crop identification, a camera height from a camera to a ground level, a crop stress indicator, a drought stress indicator, and insect indicator for different target regions, controls a machine (e.g., planter, tractor, combine, sprayer, etc.), steering the machine, and monitoring the machine or an implement (e.g., planter, combine, sprayer, etc.) that is connected to the machine with sensors and controllers located on the machine or implement.

A cab control module 1270 may include an additional control module for enabling or disabling certain components or devices of the machine or implement. For example, if the user or operator is not able to control the machine or implement using one or more of the display devices, then the cab control module may include switches to shut down or turn off components or devices of the machine or implement.

The implement 1240 (e.g., planter, cultivator, plough, sprayer, spreader, irrigation, implement, etc.) includes an implement network 150 having multiple networks, a processing system 162 having processing logic 164, a network interface 160, and optional input/output ports 166 for communicating with other systems or devices including the machine 102. The implement network 150 having multiple networks (e. g, Ethernet network, Power over Ethernet (POE) network, a controller area network (CAN) serial bus protocol network, an ISOBUS network, etc.) may include a pump 156 for pumping liquid or fluid from a storage tank(s) 190 to row units of the implement, communication modules (e.g., 180, 181) for receiving communications from controllers and sensors and transmitting these communications to the machine network. In one example, the communication modules include first and second network devices with network ports. A first network device with a port (e.g., CAN port) of communication module (CM) 180 receives a communication with data from controllers and sensors, this communication is translated or converted from a first protocol into a second protocol for a second network device (e.g., network device with a switched power line coupled with a communications channel, Ethernet), and the second protocol with data is transmitted from a second network port (e.g., Ethernet port) of CM 180 to a second network port of a second network device 113b of the machine network 110. A first network device 113a having first network ports (e.g., 1-4 CAN ports) transmits and receives communications from first network ports of the implement. In one example, the implement network 150 includes nozzles 50, and vision system 1170 having cameras and processors for various embodiments of this present disclosure.

Sensors 152 (e.g., speed sensors, seed sensors for detecting passage of seed, downforce sensors, actuator valves, OEM sensors, flow sensors, etc.), controllers 154 (e.g., drive system for seed meter, GPS receiver), and the processing system 162 control and monitoring operations of the implement.

The OEM sensors may be moisture sensors or flow sensors for a combine, speed sensors for the machine, seed force sensors for a planter, liquid application sensors for a sprayer, or vacuum, lift, lower sensors for an implement. For example, the controllers may include processors in communication with a plurality of seed sensors. The processors are configured to process data (e.g., liquid application data, seed sensor data) and transmit processed data to the processing system 162 or 120. The controllers and sensors may be used for monitoring motors and drives on a planter including a variable rate drive system for changing plant populations. The controllers and sensors may also provide swath control to shut off individual rows or sections of the planter. The sensors and controllers may sense changes in an electric motor that controls each row of a planter individually. These sensors and controllers may sense seed delivery speeds in a seed tube for each row of a planter.

The network interface 160 can be a GPS transceiver, a WLAN transceiver (e.g., WiFi), an infrared transceiver, a Bluetooth transceiver, Ethernet, or other interfaces from communications with other devices and systems including the machine 102. The network interface 160 may be integrated with the implement network 150 or separate from the implement network 150 as illustrated in FIG. 12B.

The processing system 162 communicates bi-directionally with the implement network 150, network interface 160, and I/O ports 166 via communication links 141-143, respectively. The implement communicates with the machine via wired and possibly also wireless bi-directional communications 104. The implement network 150 may communicate directly with the machine network 110 or via the network interfaces 115 and 160. The implement may also by physically coupled to the machine for agricultural operations (e.g., planting, harvesting, spraying, etc.). The memory 105 may be a machine-accessible non-transitory medium on which is stored one or more sets of instructions (e.g., software 106) embodying any one or more of the methodologies or functions described herein. The software 106 may also reside, completely or at least partially, within the memory 105 and/or within the processing system 1200 during execution thereof by the system 100, the memory and the processing system also constituting machine-accessible storage media. The software 1206 may further be transmitted or received over a network via the network interface 115.

In one embodiment, a machine-accessible non-transitory medium (e.g., memory 105) contains executable computer program instructions which when executed by a data processing system cause the system to perform operations or methods of the present disclosure

It will be appreciated that additional components, not shown, may also be part of the system in certain embodiments, and in certain embodiments fewer components than shown in FIG. 12A and FIG. 12B may also be used in a data processing system. It will be appreciated that one or more buses, not shown, may be used to interconnect the various components as is well known in the art.

### Examples—The Following Are Non-Limiting Examples

Example 1—a system comprising an implement, a plurality of cameras disposed along a field operation width of the implement to capture images of target regions of an agricultural field as the implement travels through the agricultural field, and a processor communicatively coupled to the plurality of cameras, the processor is configured to determine weed type for different species of weeds based on the captured images and to determine color data with a different color for each species of weeds.
Example 2—the system of Example 1 further comprising a display device to display the weed type for different species of weeds with a different color being displayed for each species of weeds.
Example 3—the system of any preceding Example, wherein the processor is further configured to determine weed density.
Example 4—the system of any preceding Example, further comprising a display device to display a different color shading for different levels of weed density for each species of weeds.
Example 5—the system of any preceding Example, wherein the processor is further configured to determine weed present probability per geo-referenced location based on the captured images.
Example 6—the system of any preceding Example, wherein the processor is further configured to determine a crop identification per geo-referenced location based on the captured images.
Example 7—the system of any preceding Example, wherein the processor is further configured to determine a camera height from a camera to a ground level based on the captured images.
Example 8—the system of any preceding Example, wherein the processor is further configured to determine a crop stress indicator, a drought stress indicator, and insect indicator for different target regions based on captured images of the target regions.
Example 9—the system of any preceding Example, wherein the processor is further configured to generate a histogram for display for different types of weeds present at geo-referenced locations.
Example 10—the system of any preceding Example, wherein the histogram indicates a percentage of a first type of weed for a first size, a percentage of the first type of weed for a second size, and a percentage of the first type of weed for a third size.
Example 11 is a vision system comprising a plurality of cameras disposed along a field operation width of an implement to capture images of target regions of an agricultural field as the implement travels through the agricultural field and a processor communicatively coupled to the plurality of cameras, the processor is configured to determine weed type for different species of weeds based on a computer vision analysis of the captured images and to determine color data with a different color for each species of weeds.
Example 12—The vision system of Example 11, further comprising a display device to display the weed type for different species of weeds with a different color being displayed for each species of weeds.
Example 13—The vision system of any of Examples 11-12, wherein the processor is further configured to determine weed density.
Example 14—The vision system of any of Examples 11-13, further comprising a display device to display a different color shading for different levels of weed density for each species of weeds.
Example 15—The vision system of any of Examples 11-14, wherein the processor is further configured to determine weed present probability per geo-referenced location based on the captured images.
Example 16—The vision system of any of Examples 11-15, wherein the processor is further configured to determine a camera height from a camera to a ground level based on the captured images.
Example 17—The vision system of any of Examples 11-16, wherein the processor is further configured to determine a crop stress indicator, a drought stress indicator, and insect indicator for different target regions based on captured images of the target regions.
Example 18 is a computer-implemented method, comprising receiving a sequence of images that are captured with one or more cameras disposed on an implement while the implement travels through an agricultural field, performing a computer vision analysis of the captured images to determine a weed type for different species of weeds in the agricultural field, and determining color data with a different color for each species of weeds.
Example 19—The computer-implemented method of Example 18, further comprising displaying, on a display device, the weed type for different species of weeds with a different color being displayed for each species of weeds.
Example 20—The computer-implemented method of Example 18, further comprising determining weed density and displaying, with a display device, a different color shading for different levels of weed density for each species of weeds.
Example 21 is a system comprising an implement, a first camera and a second camera disposed along a field operation width of the implement to capture images of target regions of an agricultural field as the implement travels through the agricultural field, wherein each camera includes logic that is configured to process image data from the captured images and to generate processed data, and an arbiter communicatively coupled to the plurality of cameras. The arbiter includes a processor that is configured to receive the processed data including a first weed present probability from the first camera for geo-referenced locations in the field, a second weed present probability from the second camera for geo-referenced locations in the field, and to generate a fused weed present probability for geo-referenced locations in the field based on the first weed present probability and the second weed present probability.
Example 22—The system of Example 21, wherein the fused weed present probability for geo-referenced locations in the field is based on averaging the first weed present probability and the second weed present probability.
Example 23—The system of any of Examples 21-22, wherein the processor of the arbiter is further configured to receive the processed data including a first weed density from the first camera for geo-referenced locations in the field, a second weed density from the second camera for geo-referenced locations in the field, and to generate a fused weed density for geo-referenced locations in the field based on the first weed density and the second weed density.
Example 24—The system of any of Examples 21-23, wherein the fused weed density for geo-referenced locations in the field is based on averaging the first weed density and the second weed density.
Example 25—The system of any of Examples 21-24, wherein the processor of the arbiter is further configured to receive the processed data including a first camera height from the first camera for geo-referenced locations in the field, a second camera height from the second camera for geo-referenced locations in the field, and to generate a fused camera height for geo-referenced locations in the field based on the first camera height and the second camera height.
Example 26—The system of any of Examples 21-25, wherein the processor of the arbiter is further configured to receive the processed data including a first crop detected matrix from the first camera for geo-referenced locations in the field, a second crop detected matrix from the second camera for geo-referenced locations in the field, and to generate a fused crop detected matrix for geo-referenced locations in the field based on the first crop detected matrix and the second crop detected matrix.
Example 27—The system of any of Examples 21-26, wherein the fused crop detected matrix is based on applying a logical OR function to the first crop detected matrix and the second crop detected matrix.
Example 28—The system of any of Examples 21-27, wherein a view of the first camera overlaps with a view of the second camera.
Example 29—The system of any of Examples 21-28, further comprising a plurality of nozzles disposed along a field operation width of the implement to apply fluid to target regions of the agricultural field as the implement travels through the agricultural field.
Example 30—The system of any of Examples 21-29, wherein the fused weed present probability for geo-referenced locations in the field is determined on per nozzle basis.
Example 31—The system of any of Examples 21-30, wherein the system comprises a spray applicator system.
Example 32 is a vision system comprising a first camera and a second camera disposed along a field operation width of an implement to capture images of target regions of an agricultural field as the implement travels through the agricultural field. Each camera includes logic that is configured to process image data from the captured images and to generate processed data and an arbiter communicatively coupled to the plurality of cameras. The arbiter includes a processor that is configured to receive the processed data including a first weed present probability from the first camera for geo-referenced locations in the field, a second weed present probability from the second camera for geo-referenced locations in the field, and to generate a fused weed present probability for geo-referenced locations in the field based on the first weed present probability and the second weed present probability.
Example 33—The vision system of Example 32, further comprising a third camera disposed on the implement, wherein the third camera is configured to capture images, to process image data from the captured images and to generate processed data including a third weed present probability, a third weed density, and a third crop detected matrix for geo-referenced locations in the field.
Example 34—The vision system of any of Examples 32-33, wherein the processor of the arbiter is further configured to receive the processed data including a first weed present probability from the first camera for geo-referenced locations in the field, a second weed present probability from the second camera for geo-referenced locations in the field, a third weed present probability from the third camera for geo-referenced locations in the field, and to generate a fused weed present probability for geo-referenced locations in the field based on the first weed present probability, the second weed present probability, and the third weed present probability.
Example 35—The vision system of any of Examples 32-34, wherein the processor of the arbiter is further configured to receive the processed data including a first weed density from the first camera for geo-referenced locations in the field, a second weed density from the second camera for geo-referenced locations in the field, a third weed density from the second camera for geo-referenced locations in the field, and to generate a fused weed density for geo-referenced locations in the field based on the first weed density, the second weed density, and the third weed density.
Example 36—The vision system of any of Examples 32-35, wherein the fused weed density for geo-referenced locations in the field is based on averaging the first weed density, the second weed density, and the third weed density.
Example 37—The vision system of any of Examples 32-36, wherein the processor of the arbiter is further configured to receive the processed data including a first camera height from the first camera for geo-referenced locations in the field, a second camera height from the second camera for geo-referenced locations in the field, and to generate a fused camera height for geo-referenced locations in the field based on the first camera height and the second camera height.
Example 38—The vision system of any of Examples 32-37, wherein the processor of the arbiter is further configured to receive the processed data including a first crop detected matrix from the first camera for geo-referenced locations in the field, a second crop detected matrix from the second camera for geo-referenced locations in the field, and to generate a fused crop detected matrix for geo-referenced locations in the field based on the first crop detected matrix and the second crop detected matrix.
Example 39—The vision system of any of Examples 32-38, wherein the fused crop detected matrix is based on applying a logical OR function to the first crop detected matrix and the second crop detected matrix.
Example 40—The vision system of any of Examples 32-39, wherein a view of the first camera overlaps with a view of the second camera.
Example 41—The vision system of any of Examples 32-40, wherein a view of the second camera overlaps with a view of the third camera.

The foregoing description is presented to enable one of ordinary skill in the art to make and use the invention and is provided in the context of a patent application and its requirements. Various modifications to the preferred embodiment of the apparatus, and the general principles and features of the system and methods described herein will be readily apparent to those of skill in the art. Thus, the present invention is not to be limited to the embodiments of the apparatus, system and methods described above and illustrated in the drawing figures, but is to be accorded the widest scope consistent with the spirit and scope of the appended claims.

What is claimed is:

1. A system comprising:
an implement;
a plurality of cameras disposed along a field operation width of the implement to capture images of target regions of an agricultural field as the implement travels through the agricultural field; and
a processor communicatively coupled to the plurality of cameras, the processor is configured to determine weed type for different species of weeds based on the captured images and to determine color data with a different color for each species of weeds.

2. The system of claim 1, further comprising:
a display device to display the weed type for different species of weeds with a different color being displayed for each species of weeds.

3. The system of claim 1, wherein the processor is further configured to determine weed density.

4. The system of claim 3, further comprising:
a display device to display a different color shading for different levels of weed density for each species of weeds.

5. The system of claim 1, wherein the processor is further configured to determine weed present probability per geo-referenced location based on the captured images.

6. The system of claim 1, wherein the processor is further configured to determine a crop identification per geo-referenced location based on the captured images.

7. The system of claim 1, wherein the processor is further configured to determine a camera height from a camera to a ground level based on the captured images.

8. The system of claim 1, wherein the processor is further configured to determine a crop stress indicator, a drought stress indicator, and insect indicator for different target regions based on captured images of the target regions.

9. The system of claim 1, wherein the processor is further configured to generate a histogram for display for different types of weeds present at geo-referenced locations.

10. The system of claim 9, wherein the histogram indicates a percentage of a first type of weed for a first size, a percentage of the first type of weed for a second size, and a percentage of the first type of weed for a third size.

11. A vision system comprising:
a plurality of cameras disposed along a field operation width of an implement to capture images of target regions of an agricultural field as the implement travels through the agricultural field; and
a processor communicatively coupled to the plurality of cameras, the processor is configured to determine weed type for different species of weeds based on a computer vision analysis of the captured images and to determine color data with a different color for each species of weeds.

12. The vision system of claim 11, further comprising:
a display device to display the weed type for different species of weeds with a different color being displayed for each species of weeds.

13. The vision system of claim 11, wherein the processor is further configured to determine weed density.

14. The vision system of claim 13, further comprising:
a display device to display a different color shading for different levels of weed density for each species of weeds.

15. The vision system of claim 11, wherein the processor is further configured to determine weed present probability per geo-referenced location based on the captured images.

16. The vision system of claim 11, wherein the processor is further configured to determine a camera height from a camera to a ground level based on the captured images.

17. The vision system of claim 11, wherein the processor is further configured to determine a crop stress indicator, a drought stress indicator, and insect indicator for different target regions based on captured images of the target regions.

18. A computer-implemented method, comprising:
receiving a sequence of images that are captured with one or more cameras disposed on an implement while the implement travels through an agricultural field;
performing a computer vision analysis of the captured images to determine a weed type for different species of weeds in the agricultural field; and
determining color data with a different color for each species of weeds.

19. The computer-implemented method of claim 18, further comprising:
displaying, on a display device, the weed type for different species of weeds with a different color being displayed for each species of weeds.

20. The computer-implemented method of claim 18, further comprising:
determining weed density; and
displaying, with a display device, a different color shading for different levels of weed density for each species of weeds.
